(19) United States
(12) Patent Application Publication
(10) Pub. No.: US 2013/0231950 A1
(43) Pub. Date: Sep. 5, 2013

(54) HEALTH INSURANCE REIMBURSED CREDIT CARD

(71) Applicant: Donald SPECTOR, New York, NY (US)

(72) Inventor: Donald SPECTOR, New York, NY (US)

(21) Appl. No.: 13/863,585

(22) Filed: Apr. 16, 2013

Related U.S. Application Data
(63) Continuation-in-part of application No. 12/388,248, filed on Feb. 18, 2009.
(60) Provisional application No. 61/145,752, filed on Jan. 20, 2009.
(60) Provisional application No. 61/037,611, filed on Mar. 18, 2008.

(51) Int. Cl. G06F 19/00; G06Q 20/14; G06Q 50/22

(52) U.S. Cl. CPC G06F 19/328; G06Q 50/22; G06Q 20/14
USPC 705/2

(57) ABSTRACT

An improved computerized method for provides credit card services by a card issuer. The improvement operates in connection with health insurance offered to the cardholder. In this context, the cardholder has an account with the card issuer and the improvement includes storing, in association with the account, data associated with the cardholder's insurance policy. It also includes processing incoming merchant charges to be posted to the account to flag any charge identified as covered by insurance and to store such charge as flagged. Finally it includes deferring billing of any flagged charge, pending settlement of such flagged charge under an arrangement with the insurer.

### CROSS REFERENCE TO RELATED APPLICATIONS

The present application is a continuation-in-part of U.S. patent application Ser. No. 12/388,248 filed on Feb. 18, 2009, which claims the benefit of priority under 35 U.S.C. §119(e) from U.S. Provisional Patent Application Ser. No. 61/145,752 filed Jan. 20, 2009, and U.S. Provisional Patent Application Ser. No. 61/037,611 filed Mar. 18, 2008. Each of these related applications is hereby incorporated herein by reference in its entirety.

### BACKGROUND OF THE INVENTION

1. Field of the Invention

The present invention relates to computerized systems and methods, and more particularly to computerized systems and methods for credit card services, particularly as applied to payments for health care and insurance reimbursements for the health care expenses.

2. The Prior Art

People sometimes find themselves in situations where they must receive medical treatment from doctors and other health care providers who do not accept their insurance. In these situations, the patient must generally pay the entire cost of the medical procedure themselves. However, the patient's health insurance policy will often pay for the cost of the treatment upon submission of claim, even if the doctor is “out-of-network”. Nevertheless, the claims process can be burdensome and time-consuming, often leaving the patient shouldering the entire burden of the cost for a long time.

Computerized methods and systems for providing credit card services are well known in the art. FIG. 1 illustrates how credit cards are commonly employed in transactions. Typically at least four parties are involved in a transaction involving a credit card purchase: the cardholder, the merchant, the merchant's bank, and the card issuing bank. The cardholder makes the purchase (obtaining the goods in process 105), signing a credit card charge (in process 101), which the merchant forwards to the merchant's bank, usually in a batch process (106). The merchant's bank in turn (in process 110) pays the merchant on the charge (the merchant receiving the funds in process 111) and (in process 107) forwards the charge to the card issuing bank (which receives the batch in process 108). The card issuing bank (in process 109) pays the merchant bank and debits the cardholder's credit account. The cardholder (in process 112) is billed periodically, commonly monthly, by the card issuing bank, and (in process 114) pays the card issuing bank (which receives the funds credits the account in process 115). Typically the amount received by the merchant from the merchant's bank reflects a discount for handling by the merchant's bank of its portion of the transaction, and the amount received by the merchant's bank from the card issuing bank reflects another discount for the card issuing bank's participation in the transaction.

When the charge is viewed by the merchant as substantial, the merchant may seek (in process 102) and obtain (in process 104) approval from the card issuing bank (granted in process 103) to enter into the charge transaction with the customer, and such approval provides enhanced protection against the risk that the card issuing bank will refuse to honor the cardholder's charge.

The processes described in connection with FIG. 1 are explicated and exemplified in various aspects in references including (i) a description on the web site of Bank of America at http://www.bankofamerica.com/small_business/merchant_card_processing/inde-x.cfm?template=card_processing_basics as viewed on Feb. 6, 2009 at 7:07 p.m. EST; (ii) the Wikipedia article on “Credit card” at http://en.wikipedia.org/wiki/Credit_card as viewed on Feb. 6, 2009 at 7:13 p.m. EST; U.S. Pat. No. 6,606,205 entitled “Credit Card Billing Method and System”; (iv) Chakravorti et al., “A Study of the Interrelated Bilateral Transactions in Credit Card Networks,” Federal Reserve Bank of Chicago, 2001, available at http://papers.ssrn.com/sol3/papers.cfm?abstract_id=294510 on Feb. 7, 2009; (iv) Hunt, “An Introduction to the Economics of Payment Card Networks,” Federal Reserve Bank of Philadelphia, 2003, available at www.philadelphiafed.org/research-and-data/publications/working-papers/200- 3/wp03-10.pdf on Feb. 7, 2009; “Credit Card Processing--Glossary of Terms,” available at http://www.fasttransactonline.com/credit_card_glossary.htm on Feb. 7, 2009 at 12:53 p.m. EST; U.S. Pat. No. 3,852,571 entitled “System of Transferal of Funds”; U.S. Pat. No. 4,172,552, entitled “Credit Card Processing System”; and U.S. Pat. No. 5,056,019 entitled “Automated Purchase Reward Accounting System and Method.” Each of these references is hereby incorporated herein by reference in its entirety.

### SUMMARY OF THE INVENTION

In a first embodiment of the invention there is provided an improved computerized method for providing credit card services by a card issuer. This method is of the type employing computerized processing of a stream of incoming healthcare charges to be posted and stored as debits to a cardholder's account and to generate a bill of the posted charges on a periodic basis to the cardholder's account. The improvement operates in connection with a health insurance policy purchased by the cardholder. In this context, the cardholder has an account with the card issuer and the improvement includes storing, in association with the account, data associated with the cardholder's health insurance policy. It also includes processing incoming health care charges to be posted to the account to flag any charge identified as possibly being covered by the policy and to store such charge as flagged. Finally it includes deferring billing of any flagged charge, pending settlement of such flagged charge under an arrangement with the insurer, whereby the card issuer files a claim with the insurer for the flagged amount. This type of system is particularly useful if the healthcare provider does not file a claim directly with the patient, but requires payment from the patient. These charges may in fact be covered by the patient's healthcare policy. The credit card according to the invention does not require payment from the patient until the charge has been reviewed and either denied or paid for by the insurance company.

In a further related embodiment, settlement of each flagged charge comprises using a settlement computer process and crediting of the account of the constituent with an amount corresponding to such flagged charge.

With respect to this aspect of the invention in fact several implementations can be effectuated. Typically, the transaction handling would have the health care charge generated by the provider ultimately sent to the card issuer, because the patient charged the fee on the card issuer's credit card. The card issuer flags but does not yet post the charge for billing to the patient's account. In this embodiment, the method includes filing a claim with the insurer and receiving payment from the insurer, such payment giving rise to the crediting of the account of the cardholder. If the insurer sends payment to the cardholder directly as reimbursement, the card issuer can then remove the flag from the charge and the charge will remain on the patient's account until paid. If the insurer pays the amount to the cardholder's credit card account, the charge is removed from the cardholder's account.

In a further related embodiment, the method further includes, on receipt of a communication from the insurer rejecting the claim, automatically removing the flag from the charge and posting it to the cardholder's account for billing.

Furthermore, in another related embodiment, the method also includes storing in a historical database a record of each flagged charge; updating the historical database to reflect any posting of each such flagged charge, any payment thereof, any communication from the insurer corresponding to disapproval of the charge to which such flagged charge pertains, and whether any limit on coverage of the patient has been exceeded. In addition, the method includes retrieving information from the historical database pertaining to the cardholder; and providing a report to the cardholder based on the retrieved information so as to provide the patient with a record of health care costs of the cardholder. Providing the report optionally includes causing the retrieved information to be included in the bill on the periodic basis to the cardholder.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a diagram illustrating how credit cards are commonly employed in transactions.

FIG. 2 is a block diagram of a computer network in which a computerized method for providing a healthcare credit card operates, in accordance with an embodiment of the present invention.

FIG. 3 is a flow chart of a computerized method for providing healthcare credit card services by a card issuer, in accordance with an embodiment of the present invention.

### DETAILED DESCRIPTION OF THE PREFERRED EMBODIMENT

Definitions. As used in this description and the accompanying claims, the following terms shall have the meanings indicated, unless the context otherwise requires:

“Healthcare” is any service, treatment or medicine offered to a patient, regardless whether or not covered by the patient's health insurance.

A healthcare charge is “fundable” in the previous definition if it is, for example, subject to reimbursement by an a health insurer under a policy held by the patient.

An “insurer” is an entity offering insurance, under a set of terms, for payment of healthcare costs to policyholders, under certain terms and conditions as enumerated in the individual policies.

A “patient” is a person receiving healthcare.

A “provider” is any person or entity providing healthcare. In accordance with embodiments of the present invention, the provider herein acts as a merchant in a credit card transaction for purposes of selling its healthcare services. A person receiving healthcare from the provider makes the purchase of the services by making a credit card charge. This charge, as described below, in connection with certain embodiments of the present invention, is “flagged” to cause its being deferred from being posted to the account of the card holder for billing purposes.

A “card issuer” is an entity that is in the business of providing credit card services. A card issuer may be a bank, and alternatively or in addition may be an insurer (as defined herein) or an affiliate of an insurer.

Each of the terms “debit”, “credit”, and “bill”, used herein as either a noun or a verb, refers not simply to an accounting concept but more specifically to a computerized implementation of the corresponding accounting concept. In particular, as indicated by references above including U.S. Pat. No. 6,606,205, U.S. Pat. No. 4,172,552, and U.S. Pat. No. 5,056,019, delivery of credit card services is heavily computerized, and it has long been within the skill of the art to employ computer processes to cause an amount to be debited or credited to a specific account and for a specific account to be billed.

Various embodiments of the present invention provide a health insurance credit card offered by a card issuer under an agreement with an insurer. The card issuer issues such a card to a policyholder of the insurer. This credit card is used by the policyholder, also known a the patient, to charge payment for any healthcare costs incurred by the patient. While the insurer may take time providing funding to the patient, the patient has an arrangement with the card issuer to defer interest due on the card and repayment of the credit card debt until the constituent receives funding from the insurer, or the insurer denies the funding.

Even if the provider is not an authorized provider under the patient's insurance policy, the insurer, depending on circumstances, may still pay for the provider's services, in whole or in part. These embodiments therefore allow the constituent to charge healthcare expenses without providing out-of-pocket cash or paying off the charge in installments (if reimbursement from the insurer is not forthcoming), and not paying interest, in those cases where the insurer is responsible, until the insurer actually reimburses the constituent. In other embodiments of the invention, reimbursement checks from the insurer might be directly turned over as full payment, without interest for the services.

It is believed that the health insurance credit card exemplified by various embodiments of the present invention has several unique and valuable features, including the following:

The card allows for a patient to automatically file a claims with an insurer for funding without requiring out-of-pocket expenditures by the patient, or having to pay card interest or penalties, until the insurer makes a final decision regarding coverage of the claim.

The card can provide information on each credit card billing statement that provides personalized information regarding the amount of reimbursement provided by the insurer, the amount of money she has left in her credit line, and certain other relevant financial data.

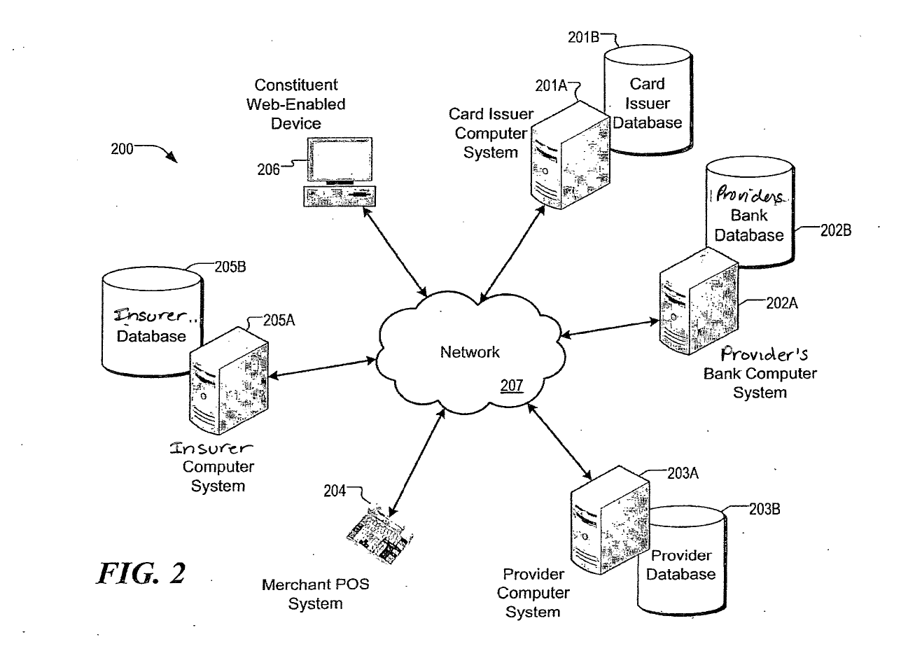

FIG. 2 is a block diagram of a computer network in which a computerized method for providing a continuing education credit card operates, in accordance with an embodiment of the present invention. The computer network of FIG. 2 includes card issuer computer system and database 201, merchant's bank computer system and database 202, provider computer system and database 203, merchant point-of-sale (POS) system 204, organization computer system and database 205, and a patient web-enabled device 206. These computer systems communicate with each other over a network 207.

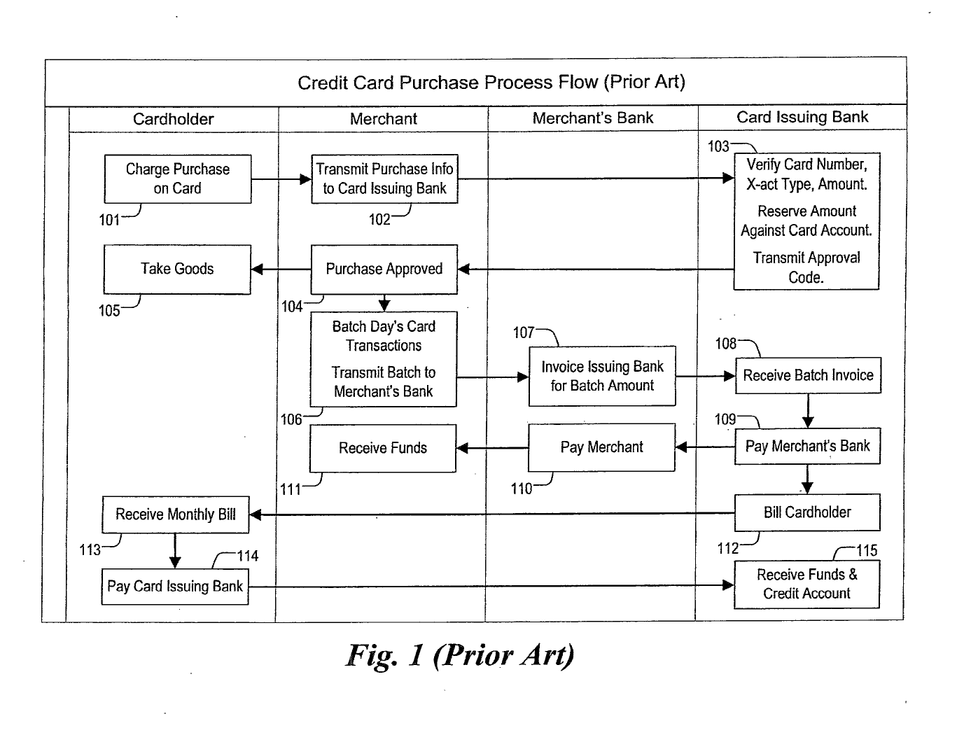

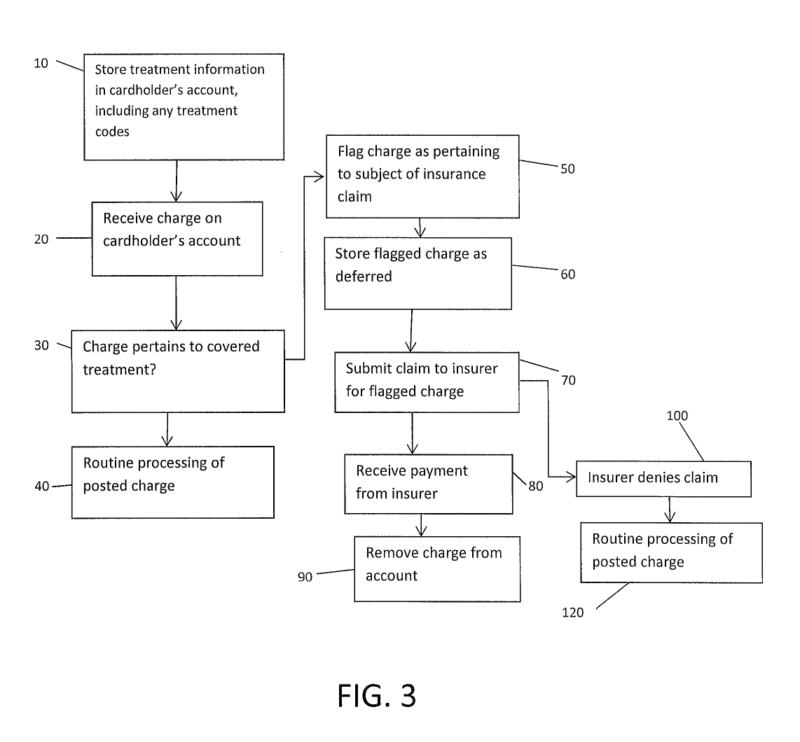

Card issuer computer system 201A and associated database 201B comprise the computer systems of the card issuer (which may be a bank) that issues a health insurance credit card to a policyholder of the insurer. Database 201B contains information related to the cardholder's account, including information related to account identification, such as cardholder personal information, and information related to the cardholder's insurance policy. Database 201B also includes information related to card transactions, such as provider charges to the account, credits to the account, and account balances and credit limits. Card issuer computer system 201A executes a series of processes, including those described in connection with FIG. 1, as part of providing health insurance credit card services in accordance with an embodiment of the invention herein. Additional processes executed on card issuer computer system 201A will be described in detail below, in relation to FIGS. 3-4.

Providers's bank computer system 202A and associated database 202B comprise the computer systems of the bank that holds business accounts of the provider. Database 202B contains business account information for the providers it services. One process that executes on provider's bank computer system 202A is periodically transmitting invoices over network 207 to the card issuer for healthcare credit card transactions received over network 207 from the provider associated with the bank, and crediting those providers' accounts for the amount of their transactions (less various fees).

Provider computer system 203A and associated database 203B comprise the computer systems of the healthcare provider. Database 203B includes patient information regarding the services provided to the patient. Provider computer system 203A transmits over network 207 to card issuer computer system 201A patient information regarding the treatment provided. This is stored in card issuer database 201B in association with a cardholder's account, for later submission to an insurer. Another process that can execute on provider computer system 203A is generating bills for healthcare services provided to the patient, and transmitting the bills over network 207 to insurer computer system 205A.

Merchant POS system 204 comprises the systems and interfaces by which a provider and patient can generate a healthcare credit card transaction. These systems and interfaces include, by way of example, point-of-sale card swipe systems at a provider's place of business, and other provider-patient interfaces by which the patient can generate a credit card transaction, including Internet based online portals by which the constituent can purchase services from the provider. Healthcare credit card transactions are transmitted from merchant POS system 204 over network 207 to other entities in computer network 200 as desired.

Insurer computer system 205A and associated database 205B comprise the computer systems of the insurer of the patient, insofar as they provide reimbursement for healthcare services charged to the patient. Processes that execute on organization computer system 205A can include receiving and paying charges from the provider, and approving or disapproving healthcare credit card debits for charges pertaining to provider services.

Constituent web-enabled device 206 comprises the systems by which the patient can access over network 207 pertinent data from the other entities of computer network 200. Such systems might include, by way of example, PCs, PDAs, and other wireless devices such as smart phones. The patient may use web-enabled device 206, for example, to access course information in provider database 203B, or to receive and pay a healthcare credit card bill generated by card issuer computer system 201A. To permit operation of the web-enabled device 206, for example, computer systems 203A and 201A of the provider and of the card issuer include web servers accessible by the web-enabled device 206.

FIG. 3 is a flow chart of a computerized method for providing healthcare credit card services by a card issuer, in accordance with an embodiment of the present invention. In process 10, information related to the insurance policy of the cardholder is stored in card issuer database 201B in association with the cardholder's healthcare credit card account.

In operation, the information stored by the card issuer will include the cardholder's insurance company, the company's address, insurance billing information, the policy number and the cardholder's date of birth, and any other information needed by the insurer to process a claim under the cardholder's health insurance policy. However, because the specifications may vary from one constituent level to another, there can be a further layer of customization associated with the information stored in process 302. Such customization may be provided by the insurer on a constituent-specific basis, or alternatively the customization may be provided by a web-interface, for example, over which the cardholder provides information. The cardholder-provided information then permits the software of the card issuer to apply the specification of the insurer in determining specifically the cardholder's eligibility for funding. Alternatively, the specification may be supplied by the insurer.

In process 20, card issuer computer system 201A receives a charge on the patient's healthcare credit card account. This transaction is received by card issuer computer system 201A over network 207 from merchant POS system 204.

In process 30, a decision branch in the card issuer software determines whether the transaction to the patient's healthcare credit card account pertains to a possibly insured service based on a comparison of the transaction information received in process 303 to general healthcare insurance guidelines. For example, if a treatment code is contained in the transaction information, then the decision branch might automatically flag the process as suitable for submission in an insurance claim. If decision branch process 30 determines that the charge to the patient's account does not pertain to an insured service, then, in process 40, the charge is posted to the card account as a current debit. In process 40, the charge is processed and billed as a routine credit card charge.

If decision branch process 30 determines that the charge to the cardholder's account does pertain to an insured service, in process 50, the charge transaction is flagged as pertaining to an insured service. In process 60, the flagged charge is stored as a debit in card issuer database 201B in association with constituent's account, and posting of the flagged debit will be deferred pending settlement of the debit.

In the meantime, a claim is filed with the insurer regarding the insured service in process 70. This procedure can be done automatically by a computer process in the card issuer's computer system, once the charge has been flagged.

In process 80, settlement of the flagged debit could be made by payment from the insurer directly to the credit card account of the cardholder, at which time the flagged charge is removed from the cardholder's account in process 90. Alternatively, in process 100, the insurer denies the claim and the debit is posted to the cardholder's account in process 120.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive. All such variations and modifications are intended to be within the scope of the present invention as defined in any appended claims.

What is claimed is:

1. An improved computerized method for providing credit card services by a card issuer, such method being of the type employing computerized processing of a stream of incoming merchant charges to be posted and stored as debits to a cardholder's account and to generate a bill of the posted charges on a periodic basis to the cardholder, wherein the improvement operates in connection with health insurance provided to the cardholder by an insurer, the cardholder having an account with the card issuer, and the improvement comprises:
storing, in association with the account, data associated with an insurance policy of the cardholder;
processing incoming merchant charges to be posted to the account to flag any charge identified as pertaining to a covered charge by the associated data and to store such charge as flagged;
filing a claim with the insurer for the flagged charge; and
deferring billing of any flagged charge, pending settlement of such flagged charge under an arrangement with the insurer.

2. A method according to claim 1, wherein settlement of each flagged charge comprises using a settlement computer process and crediting of the account of the cardholder with an amount corresponding to such flagged charge when the insurer pays the flagged charge to the cardholder's account.

3. A method according to claim 1, wherein processing incoming charges to be posted to the account to flag any charge identified as pertaining to a covered charge further includes determining whether any such charge includes a portion that is not subject to insurance coverage, and in such case: flagging only an amount of such charge excluding the portion; and separately processing the portion.

4. A method according to claim 3, wherein separately processing the portion includes posting the portion for current billing on the account of the policyholder.

5. A method according to claim 1, further comprising: on receipt of a communication from the insurer rejecting the claim, automatically removing the flag from the charge and posting it to the cardholder's account for billing.

6. A method according to claim 1, further comprising:
storing in a historical database a record of each flagged charge;
updating the historical database to reflect any posting of each such flagged charge, any payment thereof, any communication from the insurer corresponding to denial of the claim to which such flagged charge pertains; retrieving information from the historical database pertaining to the cardholder; and providing a report to the cardholder based on the retrieved information so as to provide the cardholder with a record of health care charges.

7. A method according to claim 6, wherein providing the report includes causing the retrieved information to be included in the bill on the periodic basis to the cardholder.

8. The method according to claim 1, wherein the data associated with an insurance policy of the cardholder includes at least the name and address of the insurance company, the policy number, and the cardholder's name, address and date of birth.

9. The method according to claim 1, wherein the step of filing a claim occurs automatically via a computer of the card issuer as soon as a charge is flagged.
